(19) United States
(12) Patent Application Publication
(10) Pub. No.: US 2014/0210939 A1
(43) Pub. Date: Jul. 31, 2014

(54) Presenting a Videoconference with a Composited Secondary Video Stream

(71) Applicant: LOGITECH EUROPE S.A., Morges (CH)

(72) Inventor: Wayne E. Mock, Round Rock, TX (US)

(73) Assignee: LOGITECH EUROPE S.A., Morges (CH)

(21) Appl. No.: 13/839,918

(22) Filed: Mar. 15, 2013

Related U.S. Application Data
(60) Provisional application No. 61/758,177, filed on Jan. 29, 2013.

(51) Int. Cl. H04N 7/15

(52) U.S. Cl. CPC H04N 7/152
USPC 348/14.03; 348/14.07

(57) ABSTRACT

Presenting a videoconference with a secondary video stream composited by an endpoint. The endpoint may receive, from a bridge of the videoconferencing system, information regarding videoconferencing layouts available to the bridge. The information may include geometries and arrangements of geometric spaces defined by the layouts. The endpoint may transmit a command configured to instruct the bridge to generate a composite video stream according to a specified layout. The endpoint may then receive the composite video stream and a secondary video stream. The endpoint may composite the two video streams by overlaying the secondary video stream upon a geometric space of the layout in which the bridge does not composite a component video stream.

### PRIORITY CLAIM

This application claims the benefit of U.S. Provisional Application No. 61/758,177, filed Jan. 29, 2013, titled “Remote Bridge Control without a Bridge User Interface,” the inventor being Wayne E. Mock, which is incorporated by reference in its entirety as if fully disclosed herein.

### FIELD OF THE INVENTION

The present invention relates generally to controlling a videoconferencing bridge and, more specifically, to abstracting bridge control procedures to eliminate the need for a user interface generated by the bridge.

### DESCRIPTION OF THE RELATED ART

Videoconferencing may be used to allow two or more participants at remote locations to communicate using both video and audio. Each participant location may include a videoconferencing endpoint for video/audio communication with other participants. Each videoconferencing endpoint may include a camera and microphone to collect video and audio from a first or local participant to send to another (remote) participant. Each videoconferencing endpoint may also include a display and speaker to reproduce video and audio received from one or more remote participants. Each videoconferencing endpoint may also be connected to (or comprise) a general purpose computer system to allow additional functionality into the videoconference. For example, additional functionality may include data conferencing (including displaying and/or modifying a document for both participants during the conference).

A multipoint control unit (MCU), as used herein, may operate to help connect multiple codecs or endpoints together so that a multiparty (i.e., more than 2 participants) call is possible. An MCU may also be referred to as a bridge, and the two terms are used interchangeably herein. An MCU is a videoconference controlling entity typically located in a node of the network, and may be included in one or more of the endpoints/codecs. Such an MCU may be referred to as an embedded MCU, because it is part of the endpoint/codec itself. The MCU receives several channels from access ports, processes audiovisual signals according to certain criteria, and distributes the audiovisual signals to the connected channels. The information communicated between the endpoints and the MCU may include control signals, indicators, audio, video, and/or data.

In some videoconferencing systems, a user may control some functions of a bridge through a remote videoconferencing endpoint. Typically, this requires the bridge to transmit a bridge user interface (UI) to the endpoint for display. This bridge UI provides control and status information to the user. However, this bridge UI may interfere with the local UI generated by the endpoint. For example, the two UIs may be displayed atop each other on the same portion of the screen. Additionally, the bridge UI may have a poor appearance, as a result of being transmitted to the endpoint at a low resolution and then scaled to a larger size for presentation on a display of the endpoint. Further, the bridge UI may have an appearance and feel strikingly different from that of the local UI, causing a disjointed user experience.

In some videoconferencing systems, control of a bridge through a remote videoconferencing endpoint may be executed using specific control signals, including dual-tone multi-frequency (DTMF) signals or far-end camera control (FECC) signals, such as those defined by the H.323 standard. H.323 is a standard defined by the International Telecommunications Union. However, utilizing such control signals typically requires advanced user knowledge and/or complex series of user inputs. Therefore, videoconferencing systems must typically display additional instruction through the bridge UI, informing the user regarding how to utilize such control signals. Further, if a videoconferencing endpoint may be controlled through a remote control device, these complex user inputs typically require a remote control device that is overly complex and frustrating to users. For example, current videoconferencing endpoints often have associated remote control devices where individual buttons have overloaded functionality that is not apparent or ergonomic to a lay user. Accordingly, the user is often forced to look between a user interface presented on the display of the videoconferencing endpoint and the buttons on the remote control device multiple times to perform even simple tasks. Additionally, videoconferencing endpoints may have associated remote control devices that are dedicated to a single function, such as camera control, such that multiple remote control devices are required to control the videoconferencing endpoint.

In some videoconferencing systems, the endpoint may have very limited information regarding the video stream provided by the bridge for display by the endpoint. In some videoconferencing systems, the bridge may further provide a data stream for display by the endpoint. In such systems, displaying both streams on a single display requires the endpoint to shrink both streams to one-fourth the size of the screen, so that both streams may fit on the screen without distortion and without overlap.

Thus, improvements in controlling a bridge through a remote videoconferencing endpoint are desired.

### SUMMARY OF THE INVENTION

Various embodiments are presented of methods and devices for presenting a videoconference by an endpoint in a videoconferencing system. The videoconference may be provided to the endpoint by a bridge in the videoconferencing system.

A method is presented of presenting a videoconference, wherein the method is performed by an endpoint. The endpoint may transmit, to a bridge in the videoconferencing system, an inquiry requesting the information regarding available videoconferencing layouts. In response, the endpoint may receive, from a bridge, the requested information.

In some embodiments, the information regarding available videoconferencing layouts may comprise geometries and arrangements of geometric spaces defined by the layouts. In some such embodiments, the endpoint may generate a user interface comprising a graphical list of at least a subset of the available videoconferencing layouts. The elements of the graphical list may comprise representations of the geometries and arrangements of the respective videoconferencing layouts.

After receiving the requested information, the endpoint may transmit, to the bridge, a command configured to instruct the bridge to generate a composite video stream according to one of the available videoconferencing layouts. The command may be based on user input selecting the specified layout. For example, the user input may comprise selecting an element of the graphical list of the user interface.

The composite video stream is then generated by the bridge compositing, according to the specified layout, a plurality of component video streams received from a plurality of endpoints of the videoconferencing system. The endpoint may then receive, from the bridge, the composite video stream. The endpoint may also receive a secondary video stream, and may then composite the received composite video stream with the received secondary video stream to generate an endpoint presentation. The endpoint may then display the endpoint presentation on a display of the endpoint.

In some embodiments, the specified layout may comprise a geometric space in which the bridge does not composite a component video stream. In some such embodiments, compositing the received composite video stream with the received secondary video stream may further comprise reducing the size of the secondary video stream to be equal to the size of the geometric space in which the bridge does not include a component video stream; and overlaying the secondary video stream upon the geometric space in which the bridge does not composite a component video stream.

An endpoint device of a videoconferencing system is also presented. The endpoint device may comprise a display, communication circuitry, and a processor. The processor may be configured to perform the method outlined above.

A method of providing a videoconference for presentation is also presented, wherein the method is performed by a bridge of a videoconferencing system. The bridge may receive a plurality of component video streams from a plurality of respective endpoints of the videoconferencing system. The bridge may receive, from a first endpoint of the plurality of endpoints, an inquiry requesting information regarding available videoconferencing layouts. In response, the bridge may transmit, to the first endpoint, the requested information. The bridge may then receive, from the first endpoint, a command configured to instruct the bridge to generate a composite video stream according to a specified layout. In response, the bridge may generate the composite video stream by compositing the plurality of component video streams according to the specified layout, wherein each component video stream is arranged within one of a plurality of geometric spaces defined by the specified layout. The bridge may then transmit, to the first endpoint, the composite video stream. The bridge may also transmit, to the first endpoint, a secondary video stream, wherein the first endpoint is configured to composite the composite video stream with the secondary video stream to generate an endpoint presentation.

### BRIEF DESCRIPTION OF THE DRAWINGS

A better understanding of the present invention can be obtained when the following detailed description of the embodiments is considered in conjunction with the following drawings.

FIG. 1 illustrates an exemplary videoconferencing endpoint, according to an embodiment;

FIG. 2 illustrates an exemplary simple remote control device for interacting with user interfaces, according to an embodiment;

FIG. 3 illustrates an exemplary bridge, according to an embodiment;

FIG. 4 is a flowchart diagram illustrating an embodiment of a method for presenting a videoconference;

FIG. 5 is a flowchart diagram illustrating an embodiment of a method for providing a videoconference for presentation;

FIG. 6 illustrates an exemplary embodiment of a local user interface generated by an endpoint in a videoconferencing system;

FIG. 7 illustrates an exemplary embodiment of an endpoint presentation.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Incorporation by Reference

U.S. patent application titled “Abstracting Bridge Control in a Videoconferencing System”, Ser. No. 13/751,708, which was filed Jan. 28, 2013, whose inventor is Wayne E. Mock, is hereby incorporated by reference in its entirety as though fully and completely set forth herein.

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer over a network, such as the Internet. In the latter instance, the second computer system may provide program instructions to the first computer system for execution. The term “memory medium” may include two or more memory mediums which may reside in different locations, e.g., in different computer systems that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

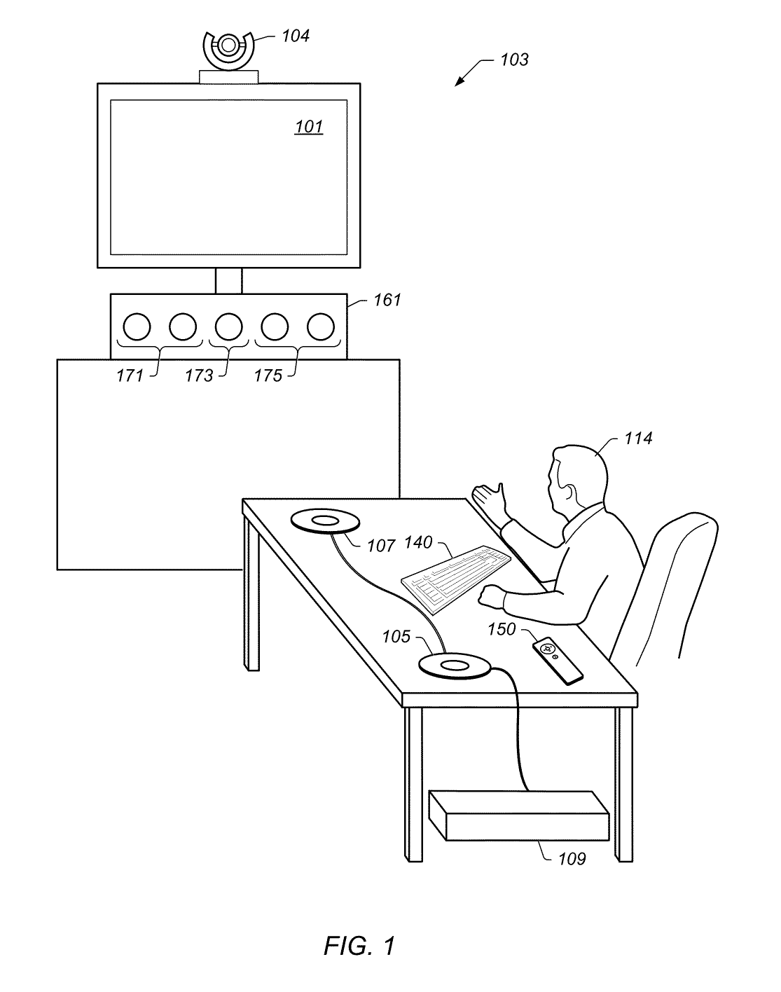

### FIG. 1—Exemplary Videoconferencing Endpoint

FIG. 1 illustrates an exemplary embodiment of a videoconferencing endpoint at a participant location. The videoconferencing endpoint may be configured to perform embodiments described herein, such as the provision of various user interfaces. The videoconferencing endpoint 103 may have a system codec (or videoconferencing unit) 109 to manage both a speakerphone 105/107 and videoconferencing hardware, e.g., camera 104, display 101, speakers 171, 173, 175, etc. The speakerphones 105/107 and other videoconferencing endpoint components may be connected to the codec 109 and may receive audio and/or video signals from the system codec 109.

In some embodiments, the videoconferencing endpoint may include camera 104 (e.g., an HD camera) for acquiring images (e.g., of participant 114) of the participant location. Other cameras are also contemplated. The videoconferencing endpoint may also include display 101 (e.g., an HDTV display). Images acquired by the camera 104 may be displayed locally on the display 101 and/or may be encoded and transmitted to other participant locations in the videoconference. In some embodiments, images acquired by the camera 104 may be encoded and transmitted to a multipoint control unit (MCU), which then provides the encoded stream to other participant locations (or videoconferencing endpoints).

The videoconferencing endpoint may further include one or more input devices, such as the computer keyboard 140. In some embodiments, the one or more input devices may be used for the videoconferencing endpoint 103 and/or may be used for one or more other computer systems at the participant location, as desired.

The videoconferencing endpoint may also include a sound system 161. The sound system 161 may include multiple speakers including left speakers 171, center speaker 173, and right speakers 175. Other numbers of speakers and other speaker configurations may also be used. The videoconferencing endpoint 103 may also use one or more speakerphones 105/107 which may be daisy chained together.

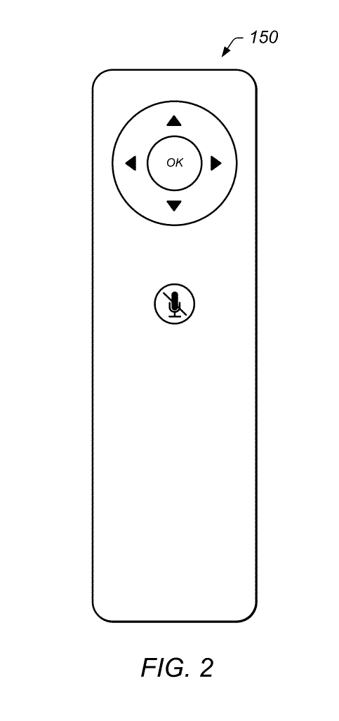

In some embodiments, the videoconferencing endpoint components (e.g., the camera 104, display 101, sound system 161, and speakerphones 105/107) may be connected to a system codec 109. The system codec 109 may be placed on a desk or on the floor. Other placements are also contemplated. The system codec 109 may comprise communication circuitry, through which it may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data, via the communication circuitry, over the network to another videoconferencing endpoint, or to an MCU for provision to other conferencing systems. The videoconferencing endpoint may be controlled by a participant or user through various mechanisms, such as a remote control device 150. The remote control device 150 may be implemented with a plurality of inputs, such as physical buttons and/or with a touch interface. In some embodiments, the remote control device 150 may be implemented as a portion of other videoconferencing devices, such as the speakerphones 107 and/or 105, and/or as a separate device. FIG. 2 provides an exemplary embodiment of simple remote control device.

In various embodiments, the codec 109 may implement a real time transmission protocol. In some embodiments, the codec 109 (which may be short for “compressor/decompressor” or “coder/decoder”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may utilize MPEG, Indeo™, and Cinepak™, among others.

In some embodiments, the videoconferencing endpoint 103 may be designed to operate with normal display or high definition (HD) display capabilities. The videoconferencing endpoint 103 may operate with network infrastructures that support Ti capabilities or less, e.g., 1.5 mega-bits per second or less in one embodiment, and 2 mega-bits per second in other embodiments.

Note that the videoconferencing endpoint(s) described herein may be dedicated videoconferencing endpoints (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing endpoint may be designed specifically for videoconferencing, and is not used as a general purpose computing platform; for example, the dedicated videoconferencing endpoint may execute an operating system which may be typically streamlined (or “locked down”) to run one or more applications to provide videoconferencing, e.g., for a conference room of a company. In other embodiments, the videoconferencing endpoint may be a general use computer (e.g., a typical computer system which may be used by the general public or a high end computer system used by corporations) which can execute a plurality of third party applications, one of which provides videoconferencing capabilities. Videoconferencing endpoints may be complex (such as the videoconferencing endpoint shown in FIG. 1) or simple (e.g., a user computer system with a video camera, input devices, microphone and/or speakers). Thus, references to videoconferencing endpoints, endpoints, etc. herein may refer to general computer systems which execute videoconferencing applications or dedicated videoconferencing endpoints. Note further that references to the videoconferencing endpoints performing actions may refer to the videoconferencing application(s) executed by the videoconferencing endpoints performing the actions (i.e., being executed to perform the actions). A videoconferencing endpoint may include an embedded bridge, or other component of a videoconferencing system.

As described herein, the videoconferencing endpoint 103 may execute various videoconferencing application software that presents a graphical user interface (GUI) on the display 101. The GUI may be used to present an address book, contact list, list of previous callees (call list) and/or other information indicating other videoconferencing endpoints that the user may desire to call to conduct a videoconference. The GUI may also present options for recording a current videoconference, and may also present options for viewing a previously recorded videoconference.

Note that the videoconferencing endpoint shown in FIG. 1 may be modified to be an audioconferencing endpoint. For example, the audioconference could be performed over a network, e.g., the Internet, using VoIP. Additionally, note that any reference to a “conferencing endpoint” or “conferencing endpoints” may refer to videoconferencing endpoints or audioconferencing endpoints (e.g., teleconferencing endpoints). In the embodiments described below, the conference is described as a videoconference, but note that the methods may be modified for utilization in an audioconference.

When performing a videoconference, the various videoconferencing endpoints may be connected in a variety of manners. For example, the videoconferencing endpoints may be connected over wide area networks (e.g., such as the Internet) and/or local area networks (LANs). The networks may be wired or wireless as desired. During a videoconference, various ones of the videoconferencing units may be connected using disparate networks. For example, two of the videoconferencing endpoints may be connected over a LAN while others of the videoconference are connected over a wide area network. Additionally, the communication links between the videoconferencing units may be implemented in a variety of manners, such as those described in the patent applications incorporated by reference above.

### FIG. 2—Exemplary Remote Control Device

FIG. 2 illustrates an exemplary remote control device 150 which may be used to implement various embodiments described herein. In this particular example, the remote control device 150 is a simple remote control device having relatively few inputs. As shown, the remote control device 150 includes directional inputs (up, down, left, right), a confirmation input (ok), and a mute input. Note that these inputs may be implemented as physical buttons, in a touch interface (e.g., with haptic or other physical feedback and/or physical features indicating the locations of the inputs), or in any other desirable manner. Generally, the simple remote control device 150 may be implemented in a manner that allows the user to use the remote control device 150 without having to look at the remote control device 150. More specifically, the remote control device 150 may be implemented such that a user may look at the remote control device 150 and begin to use the remote control device 150 without requiring further analysis of inputs or layout (e.g., due to its simplicity). This design may allow the user to visually focus only on the display 101 rather than dividing visual focus between the display 101 and the remote control device 150. Accordingly, in conjunction with a properly designed user interface may lead to a more efficient and pleasant user experience.

While only six inputs are shown in FIG. 2, more or fewer inputs may be used. For example, an additional menu input (e.g., for accessing or clearing menus), power input (e.g., for turning a device on or off), etc. may be added. However, while additional inputs are contemplated, for a simple remote control device, fewer than 8 or 10 inputs may be desired so that the user can easily remember the location and purpose of each input without requiring visual analysis. Simple remote control devices may typically avoid having dedicated alphanumeric inputs. More complex remote control devices are also envisioned (e.g., having more than 8 or 10 inputs), but design must be carefully implemented in order to overcome the typical deficiencies of complex remotes noted above.

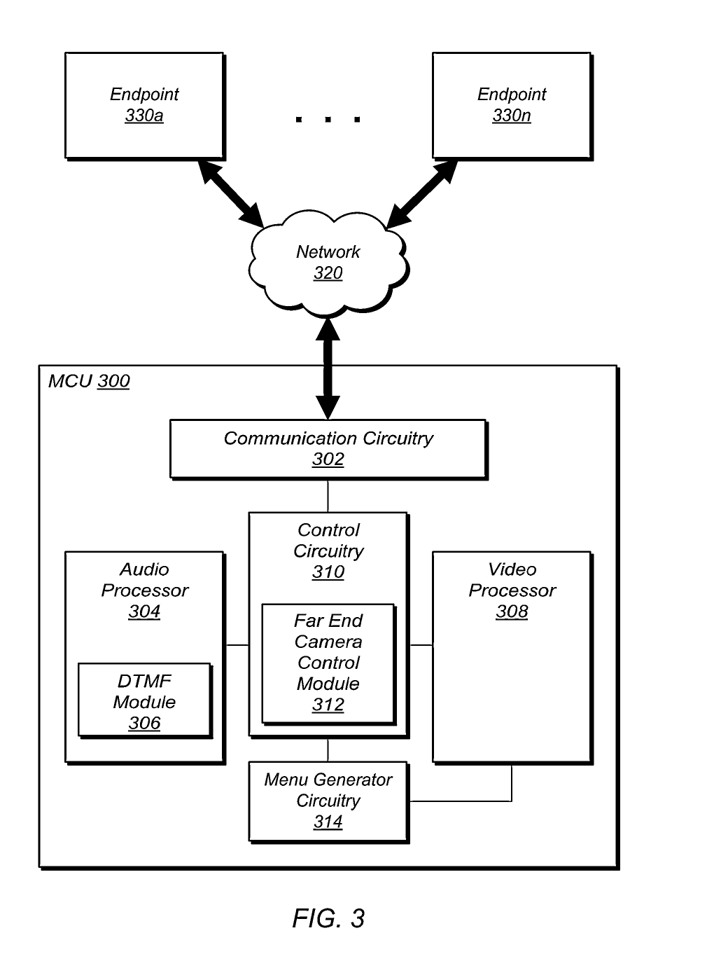

### FIG. 3—Exemplary Bridge

FIG. 3 illustrates an exemplary embodiment of an MCU 300, or bridge. The MCU may be configured to perform embodiments described herein, such as the provision of a video stream to endpoints 330a-330n via network 320.

An MCU is a videoconference controlling entity typically located in a node of the network, and may be included in one or more of the endpoints. The MCU is operable to receive videoconferencing data from one or more endpoints or other MCUs, process the videoconferencing data according to certain criteria, and transmit the processed videoconferencing data to one or more endpoints or other MCUs. In various embodiments, the MCU may be implemented in software, hardware, or a combination of both.

The videoconferencing data communicated between the endpoints 330a-330n and the MCU 300 may include control signals, indicators, audio, video, and/or data. The videoconferencing data may be communicated through a network 320, such as a LAN (local area network) or the Internet. The network may be wired or wireless, or both.

As illustrated, the MCU may comprise communication circuitry 302 capable of sending and receiving videoconferencing data via the network 320. When videoconferencing data arrives at MCU 300, the communication circuitry 302 may receive the videoconferencing data and pass it to the control circuitry 310. Such videoconferencing data may comprise one or more video streams from one or more endpoints 330a-330n. Such one or more video streams may be received by the communication circuitry 302 via multiple input channels. The communication circuitry 302 may also receive videoconferencing data from the control circuitry 310, and transmit the videoconferencing data to one or more of the endpoints 330a-330n.

The control circuitry 310 may receive videoconferencing data from the communication circuitry 302, and may further process the data. For example, the control circuitry 310 may route an audio component of the videoconferencing data to the audio processor 304, and may route a video component of the videoconferencing data to the video processor 308. The control circuitry 310 may also identify control or data components of the videoconferencing data. For example, the control circuitry 310 may identify metadata signals comprised in the videoconferencing data. The control circuitry 310 may comprise a FECC module 312, which may be configured to identify and process FECC signals comprised in the videoconferencing data. For example, the FECC module 312 may decide whether a FECC signal should be forwarded to a remote endpoint or processed as a bridge control command.

Upon receiving a control signal, e.g. a FECC signal identified by the FECC module 314 or a DTMF signal identified by the DTMF module 306, the control circuitry 310 may modify settings of the MCU 300 or send control signals to the menu generator circuitry 314, based upon the control signal received.

The control circuitry 310 may also send videoconferencing data to the communication circuitry 302 for transmission. The videoconferencing data may comprise audio data received from the audio processor 304 and video data received from the video processor 308. The videoconferencing data may also comprise metadata or control signals.

The audio processor 304 may receive audio data from the control circuitry 310, which may comprise audio portions of the videoconferencing data received from the endpoints 330a-330n. The audio processor 304 may also receive audio data from other sources, such as a local audio input device, not shown. The audio processor 304 is further configured to process the audio data according to certain criteria, and output the data to the control circuitry 310. For example, the audio processor 304 may composite the received audio data, and output the composite audio data. The audio processor 304 may comprise a DTMF module 306, which may recognize DTMF signals comprised in the received audio. Upon detecting a DTMF signal, the DTMF module may process the DTMF signal and output an appropriate control signal to the control circuitry 310.

The video processor 308 may receive video data from the control circuitry 310, which may comprise video portions of the videoconferencing data received from the endpoints 330a-330n. The video processor 308 may also receive video data from other sources, such as the menu generator circuitry 314 or a local video input device, not shown. The video processor 308 is further configured to process the video data according to certain criteria, and output the data to the control circuitry 310. For example, the video processor 308 may composite the received video data, and output the composite video data.

The menu generator circuitry 314 may receive control signals from the control circuitry 310. Based upon the control signals, the menu generator circuitry 314 may generate a user interface (UI) menu, and may provide the UI menu to the video processor 308. The video processor 308 may include the UI menu while processing the video data. For example, the video processor 308 may overlay the UI menu upon the composite video data before outputting the video data to the control circuitry 310.

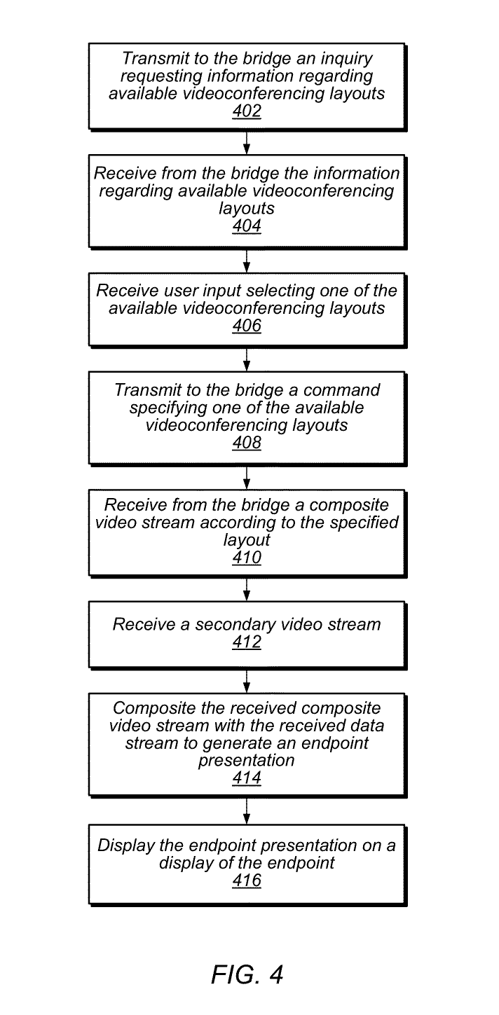

FIG. 4—Presenting a Videoconference with a Composited Secondary Video Stream

FIG. 4 is a flowchart diagram illustrating an embodiment of a method for presenting a videoconference. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In some embodiments, the method is performed by a remote endpoint of the videoconferencing system. A remote endpoint is any endpoint of the videoconferencing system in which the bridge to be controlled is not embedded, although the bridge may be embedded in another endpoint of the videoconferencing system. A remote endpoint may or may not be physically located near the bridge.

In 402, the endpoint may transmit to the bridge an inquiry requesting information regarding available videoconferencing layouts.

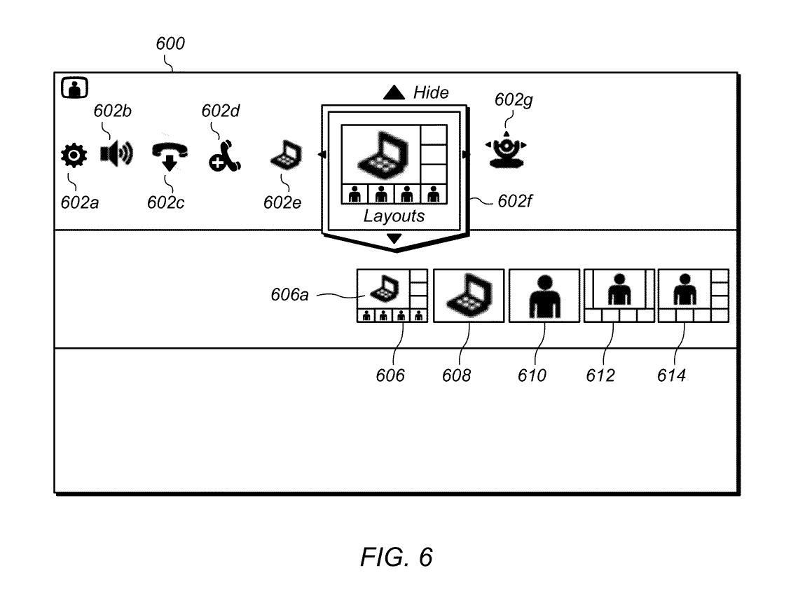

A videoconferencing layout may define the placement of component video streams within a composite video stream generated by the bridge. Specifically, the bridge may composite a plurality of component video streams into a composite video stream by arranging each component video stream within a geometric space defined by the layout. The bridge may use additional processes to determine which component video stream is arranged in each geometric space. Representations of exemplary layouts are illustrated in FIG. 6, elements 606-614. For example, layout 610 shows a layout in which the composite video stream comprises a single component video stream. Layout 614, by contrast, shows a layout in which the composite video stream comprises eight component video streams, displayed in two different sizes. In some embodiments, the layout may additionally define one or more geometric spaces in which the bridge may not composite any component video stream. For example, layout 606 illustrates a layout in which nine-sixteenths of the area of the composite video stream (606a) is reserved to display other data. Thus, the bridge may not composite any component video stream in the geometric space 606a.

An inquiry transmitted by the endpoint may request a variety of information regarding videoconferencing layouts available to the bridge. For example, the endpoint may request a list of the names of the layouts available to the bridge. As another example, the endpoint may request the geometries and arrangements of the geometric spaces defined by the layouts. Additionally, the endpoint may request further information not relating to available videoconferencing layouts. For example, the endpoint may request status information regarding one or more other endpoints of the videoconferencing system. For example, the endpoint may request information regarding whether another endpoint is currently participating in the videoconference, whether the audio input device of the other endpoint is currently muted, or whether the video input device of the other endpoint is currently deactivated. In some embodiments, the inquiry may comprise a remote procedure call (RPC). In some embodiments, the inquiry may comprise a REST/JSON (Representational State Transfer/JavaScript Object Notation) communication.

In 404, the endpoint may receive from the bridge some or all of the requested information regarding available videoconferencing layouts. In some embodiments, the endpoint may generate and display a graphical list of some or all of the available videoconferencing layouts in a user interface (UI) on a display of the endpoint, such as display 101. In some embodiments, the graphical list may include the requested information regarding the available videoconferencing layouts. FIG. 6 illustrates an exemplary UI 600 displaying information regarding available layouts. The exemplary UI 600 includes videoconference configuration options 602a-602g. As illustrated, the user has selected the “Layouts” configuration option 602f, causing the UI 600 to display a graphical list of some or all of the available layouts 606-614. In this exemplary embodiment, the endpoint may use received information regarding the geometries and arrangements of each layout to display in the graphical list a representation of each layout. Thus, each element of the graphical list comprises a representation of the geometries and arrangements of the respective layout. Such a graphical list allows a user to select the desired layout directly, without the limitations of the prior art.

Specifically, in the prior art, an endpoint would typically have little or no knowledge of the available layouts that could be provided by the bridge. Thus, in the prior art, the endpoint could not display graphical representations of the layouts, or even a more basic list of available layouts. Therefore, if a user desired to change the layout of the video stream, the user was forced to command the endpoint merely to instruct the bridge to select the next layout in the list of available layouts. The user typically would not know what the next layout would be until it was selected and transmitted by the bridge and displayed by the endpoint. In this manner, a user of a prior art system would scroll through available layouts until finding the desired layout. By contrast, in this exemplary embodiment, the user may select the desired layout directly, from the displayed list of available layouts 606-614.

In some embodiments, the requested information may be received from the bridge as a returned value in an RPC transmitted in step 402. In other embodiments, the information may be received as a part of a distinct communication event.

In 406, the endpoint may receive user input selecting one of the available videoconferencing layouts. For example, in the exemplary embodiment of FIG. 6, the user may use a remote control device, such as remote control device 150, or another control device of the endpoint, to select one of the available layouts 606-614.

In 408, the endpoint may transmit to the bridge a command specifying one of the available videoconferencing layouts. The specified layout may be the layout selected by the user input of step 406. The command may be configured to cause the bridge to generate a composite video stream according to the specified layout. The composite video stream may be generated by the bridge compositing a plurality of component video streams received from a plurality of endpoints of the videoconferencing system. For example, if layout 614 was the specified layout, the bridge may composite up to eight component video streams. A first component video stream, received from a first endpoint, may be reduced by the bridge to three-fourths size, and placed in the composite video stream as illustrated by layout 614. Up to seven other component video streams, received from up to seven other endpoints, may each be reduced by the bridge to one-sixteenth size, and placed in the composite video stream, arranged as illustrated by layout 614.

In 410, the endpoint may receive from the bridge a composite video stream according to the specified layout.

In 412, the endpoint may receive a secondary video stream. In some embodiments, the secondary video stream may comprise a data presentation display. For example, the secondary video stream may comprise a slideshow or a representation of a computer monitor display of a computer associated with one of the endpoints of the videoconferencing system. In some embodiments, the secondary video stream may be received from the bridge. In other embodiments, the secondary video stream may be received from another source, such as a local source. For example, the secondary video stream may comprise a slideshow received from a computer associated with the endpoint. In embodiments in which the secondary video stream is received from a local source, the endpoint may transmit the secondary video stream to the bridge for distribution to the other endpoints in the videoconferencing system.

In 414, the endpoint may composite the received composite video stream with the received secondary video stream to generate an endpoint presentation. In some embodiments, the endpoint may composite the received secondary video stream upon a geometric space in which no component video stream may be placed by the bridge. For example, if the composite video stream is arranged according to exemplary layout 606, the endpoint may composite the received secondary video stream upon geometric space 606a. Because the endpoint may have received information regarding the geometries and arrangements of the geometric spaces of the layouts, the endpoint may composite the received secondary video stream overlaid upon a portion of the received composite video stream without blocking any portion of the composite video stream comprising participant video.

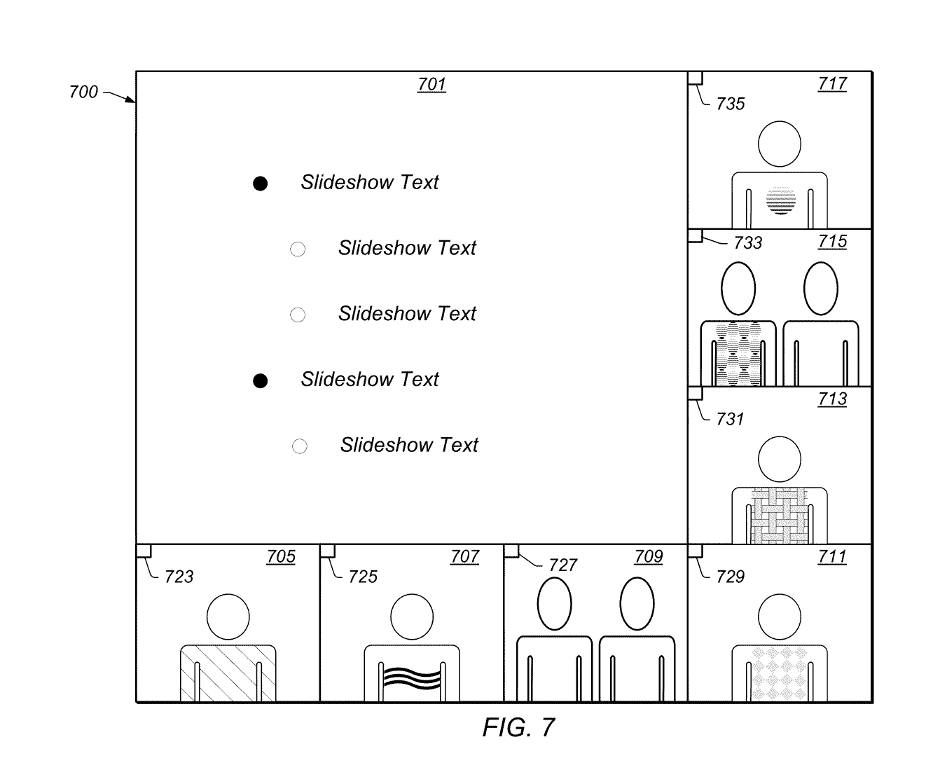

FIG. 7 illustrates an example of an endpoint presentation 700 in which a secondary video stream 701 has been composited with a received composite video stream. Specifically, FIG. 7 illustrates an example of an endpoint presentation 700 in which a secondary video stream 701 has been composited with a received composite video stream arranged according to layout 606. As illustrated, the secondary video stream 701 comprises a slideshow presentation including bullet-points with associated text. As illustrated, the endpoint may reduce the secondary video stream 701 to three-fourths size, and may composite the secondary video stream 701 upon geometric space 606a of exemplary layout 606. As illustrated, the remaining seven geometric spaces of layout 606 are populated with component video streams 705-717 composited by the bridge into the received composite video stream. As illustrated, the received composite video stream is not reduced in size.

FIG. 7 illustrates one advantage of the present method over the prior art. Specifically, in the prior art, the endpoint would typically have little or no knowledge of the layout or other information regarding the video stream provided by the bridge for display by the endpoint. In particular, the endpoint would have no knowledge regarding portions of the video stream comprising participant video. Thus, an endpoint could not overlay two video streams without a risk of obscuring a portion of a video stream comprising participant video. As a result, if two video streams were to be displayed on a single display without obscuring participant video, the endpoint was typically required to display the two video streams adjacently, which required shrinking both video streams to one-fourth the size of the display. By contrast, in the present embodiment, the endpoint may overlay the secondary video stream upon a portion of the received composite video stream known to contain no participant video, potentially allowing both video streams to be displayed at a larger size, as illustrated by FIG. 7.

In some embodiments, the endpoint may further include additional videoconference information in the endpoint presentation. For example, the endpoint presentation may include status or identification information regarding each of the other endpoints in the videoconferencing system.

FIG. 7 illustrates an example of an endpoint presentation 700 in which additional videoconference information may be included. As illustrated in FIG. 7, each of the component video streams 705-717 has overlaid upon it a status field (723-735). In some embodiments, each status field may comprise an icon or other indication of the status of the endpoint associated with the respective component video stream. For example, if the endpoint associated with component video stream 705 currently has a muted audio input device, then status field 723 may comprise a “mute” icon, to indicate the status of the associated endpoint. In this exemplary embodiment, the endpoint may use received information regarding the geometries and arrangements of each layout, as well as received information regarding the status of other endpoints, to display a status field associated with a composite video stream within the proper geometric space of the layout. Other fields, e.g. identification information, may be similarly displayed within the proper geometric space of the layout.

In the prior art, such a status indicator associated with a component video stream can typically be generated only by the bridge or by the endpoint generating the component video stream. Because a prior art endpoint displaying a composite video stream has little or no knowledge of the layout or other information comprised in the video stream, the endpoint cannot overlay status fields upon the respective component video streams comprised in the video stream. In the prior art, status fields generated by the bridge or other endpoints may have a poor appearance, as a result of being transmitted by the bridge at a low resolution, and then scaled to a larger size for presentation on a display of the endpoint. Further, status fields generated by the bridge or other endpoints may have an appearance and feel strikingly different from that of the local UI, causing a disjointed user experience. By contrast, in the present embodiment, the endpoint may generate one or more of status fields 723-735, and may include the generated status fields in the endpoint presentation.

In 416, the endpoint may display the endpoint presentation on a display of the endpoint, such as display 101.

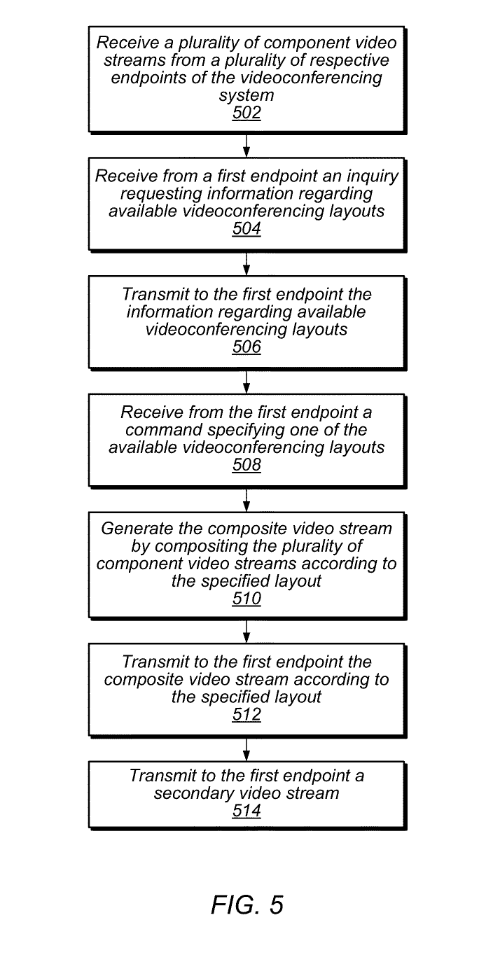

FIG. 5—Providing a Videoconference for Compositing with a Secondary Video Stream

FIG. 5 is a flowchart diagram illustrating an embodiment of a method for providing a videoconference for presentation according to the method of FIG. 4. The method shown in FIG. 5 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In some embodiments, the method is performed by a bridge of the videoconferencing system.

In 502, the bridge may receive a plurality of component video streams from a plurality of respective endpoints of the videoconferencing system.

In 504, the bridge may receive, from a first endpoint of the plurality of endpoints, an inquiry requesting information regarding available videoconferencing layouts, as discussed above with reference to FIG. 4. In some embodiments, the first endpoint may be a remote endpoint.

An inquiry received by the bridge may request a variety of information regarding videoconferencing layouts available to the bridge. For example, the inquiry may request a list of the names of the layouts available to the bridge. As another example, the endpoint may request the geometries and arrangements of the geometric spaces defined by the layouts. In some embodiments, the inquiry may comprise a remote procedure call (RPC). In some embodiments, the inquiry may comprise a REST/JSON (Representational State Transfer/JavaScript Object Notation) communication.

In 506, the bridge may transmit to the first endpoint some or all of the requested information regarding available videoconferencing layouts. The transmitting may be in response to the inquiry received in step 504. In some embodiments, the bridge may transmit the requested information as a returned value in an RPC received in step 504. In other embodiments, the information may be transmitted as a part of a distinct communication event.

In 508, the bridge may receive from the first endpoint a command specifying one of the available videoconferencing layouts. The command may be configured to cause the bridge to generate a composite video stream according to the specified layout.

In 510, the bridge may generate the composite video stream by compositing the plurality of component video streams according to the specified layout. Specifically, the bridge may composite the plurality of component video streams into a composite video stream by arranging each component video stream within a geometric space defined by the layout. In some embodiments, the bridge may generate the composite video stream in response to receiving the command of step 508. For example, if the command of step 508 specified layout 614, the bridge may generate the composite video stream by compositing up to eight component video streams according to layout 614. The bridge may reduce a first component video stream to three-fourths size, and may arrange the first component video stream in the largest geometric space of layout 614. The bridge may further reduce each of up to seven other component video streams to one-sixteenth size, and may arrange each of the other component video streams in one of the remaining geometric spaces of layout 614.

In some embodiments, the bridge may use additional processes to determine which component video stream is arranged in each geometric space. In some embodiments, such additional processes may be defined at least in part by user preferences. For example, in some embodiments, one component video stream may be designated as a primary participant component video stream, and may therefore be arranged within the largest geometric space of the specified layout. As another example, the component video stream having the greatest audio component may be arranged within the largest geometric space of the specified layout. In some embodiments, the videoconference may include more endpoints than geometric spaces defined by the selected layout. In such embodiments, the bridge may use similar or additional processes to determine which component video streams to include in the composite video stream.

In 512, the bridge may transmit to the first endpoint the composite video stream according to the specified layout.

In 514, the bridge may transmit to the first endpoint a secondary video stream. In some embodiments, the secondary video stream may comprise a data presentation display. For example, the secondary video stream may comprise a slideshow or a representation of a computer monitor display of a computer associated with one of the endpoints of the videoconferencing system. In some embodiments, the bridge may receive the secondary video stream from one of the endpoints of the plurality of endpoints other than the first endpoint.

### Advantages

The described embodiments may provide at least the following advantages. As indicated in the description of the related art, previous methods required an endpoint to shrink a received video stream and a received secondary video stream each to one-fourth of the size of the display in order to display both streams simultaneously. By contrast, using the methods described above, a user may select a videoconferencing layout that allows a secondary video stream to be composited atop a video stream without blocking any participant video. This allows both the composite video stream and the secondary video stream to be displayed at a larger size, resulting in a more satisfying user experience.

Additionally, using the methods described above, a user may select a desired layout directly from a graphical list of available layouts, without needing to scroll blindly through the available layouts.

Additionally, using the methods described above, an endpoint may display additional information, such as status or identification information regarding other endpoints in the videoconferencing system, in a manner consistent with other portions of the local UI.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of presenting a videoconference, wherein the method is performed by an endpoint of a videoconferencing system, the method comprising:
receiving, from a bridge, information regarding available videoconferencing layouts;
transmitting, to the bridge, after said receiving information, a command configured to instruct the bridge to generate a composite video stream according to a specified one of the available videoconferencing layouts, wherein the composite video stream is generated by the bridge compositing, according to the specified layout, a plurality of component video streams received from a plurality of endpoints of the videoconferencing system;
receiving, from the bridge, after said transmitting a command, the composite video stream;
receiving a secondary video stream;
compositing the received composite video stream with the received secondary video stream to generate an endpoint presentation; and
displaying the endpoint presentation on a display of the endpoint.

2. The method of claim 1, further comprising:
receiving user input selecting the specified one of the available videoconferencing layouts, wherein said transmitting the command is in response to said receiving user input.

3. The method of claim 1, further comprising:
transmitting, to the bridge, prior to said receiving information, an inquiry requesting the information regarding available videoconferencing layouts.

4. The method of claim 1, wherein the information regarding available videoconferencing layouts comprises geometries and arrangements of geometric spaces defined by the layouts.

5. The method of claim 4, further comprising:
generating a user interface comprising a graphical list of at least a subset of the available videoconferencing layouts.

6. The method of claim 5, in which an element of the graphical list comprises a representation of the geometries and arrangements of the respective videoconferencing layout.

7. The method of claim 4, wherein the specified layout comprises a geometric space in which the bridge does not composite a component video stream.

8. The method of claim 7, wherein said compositing the received composite video stream with the received secondary video stream further comprises:
reducing the size of the secondary video stream to be equal to the size of the geometric space in which the bridge does not include a component video stream; and
overlaying the secondary video stream upon the geometric space in which the bridge does not composite a component video stream.

9. An endpoint device in a videoconferencing system, comprising:
a display;
communication circuitry; and
a processor configured to:
receive, from a bridge via the communication circuitry, information regarding available videoconferencing layouts;
transmit, to the bridge via the communication circuitry, after said receiving information, a command configured to instruct the bridge to generate a composite video stream according to a specified one of the available videoconferencing layouts, wherein the composite video stream is generated by the bridge compositing, according to the specified layout, a plurality of component video streams received from a plurality of endpoints of the videoconferencing system;
receive, from the bridge via the communication circuitry, after said transmitting a command, the composite video stream;
receive a secondary video stream;
composite the received composite video stream with the received secondary video stream to generate an endpoint presentation; and
display the endpoint presentation on the display.

10. The endpoint device of claim 9, wherein the processor is further configured to:
a user input device;
wherein the processor is further configured to:
receive user input, via the user input device, selecting the specified one of the available videoconference layouts, wherein said transmitting the command is in response to said receiving user input.

11. The endpoint device of claim 9, wherein the processor is further configured to:
transmit, to the bridge via the communication circuitry, prior to said receiving information, an inquiry requesting the information regarding available videoconferencing layouts.

12. The endpoint device of claim 9, wherein the information regarding available videoconferencing layouts comprises geometries and arrangements of geometric spaces defined by the layouts.

13. The endpoint device of claim 12, wherein the processor is further configured to:
generate a user interface comprising a graphical list of at least a subset of the available videoconferencing layouts.

14. The endpoint device of claim 13, in which an element of the graphical list comprises a representation of the geometries and arrangements of the respective videoconferencing layout.

15. The endpoint device of claim 12, wherein the specified layout comprises a geometric space in which the bridge does not composite a component video stream.

16. The endpoint of claim 15, wherein said compositing the received composite video stream with the received secondary video stream further comprises:
reducing the size of the secondary video stream to be equal to the size of the geometric space in which the bridge does not include a component video stream; and
overlaying the secondary video stream upon the geometric space in which the bridge does not composite a component video stream.

17. A method of providing a videoconference for presentation, wherein the method is performed by a bridge of a videoconferencing system, the method comprising:
receiving a plurality of component video streams from a plurality of respective endpoints of the videoconferencing system;
transmitting, to a first endpoint of the plurality of respective endpoints, information regarding available videoconferencing layouts;
receiving, from the first endpoint, after said transmitting information, a command configured to instruct the bridge to generate a composite video stream according to a specified one of the available videoconferencing layouts;
generating, in response to said receiving the command, the composite video stream by compositing the plurality of component video streams according to the specified layout, wherein each component video stream is arranged within one of a plurality of geometric spaces defined by the specified layout;
transmitting, to the first endpoint, the composite video stream; and
transmitting, to the first endpoint, a secondary video stream, wherein the first endpoint is configured to composite the composite video stream with the secondary video stream to generate an endpoint presentation.

18. The method of claim 17, further comprising:
receiving, from the first endpoint, an inquiry requesting the information regarding available videoconferencing layouts, wherein said transmitting information is in response to said receiving the inquiry.

19. The method of claim 17, wherein the information regarding available videoconferencing layouts comprises geometries and arrangements of geometric spaces defined by the layouts.

20. The method of claim 19, wherein the specified layout comprises a geometric space in which the bridge does not composite a component video stream.
